(19) United States
(12) Patent Application Publication
(10) Pub. No.: US 2025/0083824 A1
(43) Pub. Date: Mar. 13, 2025

(54) FUEL CELL INTEGRATED IN WING LEADING EDGE

(71) Applicant: ZeroAvia, Inc., Hollister, CA (US)

(72) Inventors: Valery Miftakhov, Hollister, CA (US); Bob L. Mackey, Hollister, CA (US); Christian Bailey, Hollister, CA (US)

(21) Appl. No.: 18/465,875

(22) Filed: Sep. 12, 2023

(51) Int. Cl. B64D 15/12; B64D 41/00; H01M 8/04029; H01M 8/04746

(52) U.S. Cl. CPC B64D 15/12; B64D 41/00; H01M 8/04029; H01M 8/04768; B64D 2041/005; H01M 2250/20

(57) ABSTRACT

Ram air cooling demands of a fuel-cell-powered aircraft are reduced by conducting exothermic heat generated by the fuel cells to a leading edge and/or trailing edge of the aircraft wings. The beat also may be used to deice the wings.

### TECHNICAL FIELD

The present disclosure relates to hydrogen fuel cell electric engine systems for use with vehicles such as aircraft and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

Exhaust emissions from transport vehicles are a significant contributor to climate change. Conventional fossil-fuel-powered aircraft engines release CO₂ emissions. Also, fossil-fuel-powered aircraft emissions include non-CO₂ effects due to nitrogen oxide (NOx), vapor trails, and cloud formation triggered by the altitude at which aircraft operate. These non-CO₂ effects are believed to contribute twice as much to global warming as aircraft CO₂ and are estimated to be responsible for two-thirds of aviation's climate impact. Additionally, the high-speed exhaust gasses of conventional fossil-fuel-powered aircraft engines contribute significantly to the extremely large noise footprint of commercial and military aircraft, particularly in densely populated areas.

Rechargeable battery-powered terrestrial vehicles, i.e., “EVs”, are slowly replacing conventional fossil-fuel-powered terrestrial vehicles. However, the weight of batteries and limited energy storage of batteries makes rechargeable battery-powered aircraft generally impractical.

Hydrogen fuel cells offer an attractive alternative to fossil-fuel-burning engines. Hydrogen fuel cell tanks may be quickly filled and store significant energy, and other than the relatively small amount of unreacted hydrogen gas, the reaction output exhausted from hydrogen fuel cells comprises essentially only water.

A hydrogen fuel cell is an electrochemical cell that converts chemical energy into electrical energy by spontaneous electrochemical reduction-oxidation (redox) reactions. Fuel cells include an anode and a cathode separated by a proton exchange membrane (PEM) that permits only protons to pass between the anode and cathode. During operation, a fuel (e.g., hydrogen) is supplied to the anode, and an oxidant (e.g., oxygen or air) is supplied to the cathode. The fuel is oxidized at the anode, producing positively charged ions (i.e., hydrogen protons) and electrons. The positively charged protons travel through the PEM from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water. The reaction between oxygen and hydrogen is exothermic, generating heat that needs to be removed from the fuel cell.

Hydrogen fuel cells may be used as power sources for electric motors of electric vehicles and hybrid electric vehicles, including aircraft. In such applications, fuel cells are oftentimes arranged in stacks of multiple cells and connected in a series or parallel arrangement to achieve a desired power and output voltage. Cooling systems for hydrogen fuel-cell-powered vehicles oftentimes use airflow generated during movement of the vehicle as a heat transfer medium. For example, ambient airflow may be directed from outside the vehicle through an air intake of the vehicle and through one or more heat exchangers disposed within the vehicle. Airflow generated in this manner is oftentimes referred to as ram air, and, when ram air is used as a cooling medium in a vehicle, the vehicle may experience increased drag, which may reduce the energy efficiency of the vehicle.

Heat management systems such as heat exchangers or coolant media in hydrogen fuel-cell-powered aircraft also increase the overall weight and volume of the system. Improvements in cooling efficiency directly impact cost per kW and enable operation at higher altitudes.

In accordance with Aspect A of the present disclosure, there is provided a fuel-cell-powered aircraft system in which a fuel cell assembly is carried within a wing of an aircraft, and in thermal contact with a surface of the wing, such as one or more of the leading edge of the wings or the trailing edge of the wings. The fuel cells may be in direct thermal contact with the surface of the wings or in thermal contact through heat pipes configured to transport heat from the fuel cells to the surface of the wings to an internal coolant loop.

In one embodiment of the fuel-cell-powered aircraft system, the fuel cell assembly comprises a plurality of fuel cells, assembled in a stack for packaging within the wings of the aircraft.

In a further embodiment of the fuel-cell-powered aircraft system, the system includes a controller configured to control flow of coolant to heat pipes in contact with the leading edge of the wing and/or in contact with the trailing edge of the wing.

In another embodiment of the fuel-cell-powered aircraft system, the system includes a controller which is configured to switch flow of coolant to heat pipes in contact with the leading edge of the wing and the trailing edge of the wing.

In a further embodiment of the fuel-cell-powered aircraft system, the fuel cell assembly comprises a plurality of fuel cells assembled in parallel.

In yet another embodiment of the fuel-cell-powered aircraft system, the fuel cell assembly comprises a plurality of fuel cells assembled in series.

In another embodiment of the fuel-cell-powered aircraft system, the system comprises a controller for controlling flow of coolant through the coolant loop.

According to Aspect B there is provided a method for deicing wings of a fuel-cell-powered aircraft, comprising conducting exothermic heat generated by fuel cells to wings of the aircraft.

According to one embodiment of Aspect B, the exothermic heat is conducted by direct thermal contact with the fuel cells.

According to another embodiment of Aspect B, the exothermic heat is conducted via heat pipes in contact with the fuel cells.

According to a further embodiment of Aspect B, the exothermic heat is directed to a surface of the aircraft wings.

According to yet another embodiment of Aspect B, the surface comprises one or more of a leading edge of the aircraft wings and/or a trailing edge of the aircraft wings.

According to Aspect C, there is provided a method for reducing ram air cooling demands of a fuel-cell-powered aircraft comprising conducting exothermic heat generated by fuel cells to wings of the aircraft.

According to one embodiment of Aspect C, the exothermic heat is directed to a surface of the aircraft wings.

According to another embodiment of Aspect C, the surface comprises one or more of a leading edge of the aircraft wings and/or a trailing edge of the aircraft wings.

Heating the leading edge (and more generally the aircraft wing skin) may impact aerodynamic performance of the aircraft by reducing air density around the wing. In particular, raising the temperature of the wing leading edge reduces the low-pressure region of the upper surface of the wing, and thus decreases lift and drag coefficient along with the stall angle of the wing. Thus, heating the wing leading edge and more generally the wing skin would be considered counterintuitive to aerodynamic efficiency. However, the actual influence on aerodynamics of heating the wing skin is relatively weak, particularly at lower angles of attack. Thus, as a practical matter, the net reduction of lift has less of an effect than the increased aerodynamic efficiency achieved by the instant disclosure in terms of reducing the amount of drag resulting from a reduction in the amount of ram air required for cooling the fuel cells, particularly at cruise. Furthermore, at the trailing edge of the wing, airflow is more likely to have transitioned to turbulence, and therefore, heat rejection at the trailing edge will have less of an impact.

Also, an additional benefit of heating the leading edge that results from using rejected heat from the fuel cells is that the heat may be used to deice the aircraft wings. This eliminates the need for a dedicated deicing system which adds weight and additional consumption of electrical energy for resistive heating.

Also, reducing air density around the wing permits a higher or faster cruise speed. Thus, the negative impact of raising the temperature of the leading edge and wing surface and more particularly the temperature of the wing skin in accordance with the present disclosure is wholly or partially offset by the increased aerodynamic efficiency resulting from reduced drag by reduction of ram air cooling requirements.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

In the drawings:

FIG. 1 is a schematic view of a hydrogen fuel-cell-powered aircraft having fuel cell assemblies carried within the wings of the aircraft in accordance with the present disclosure;

FIG. 2 is a schematic view showing details of a modular fuel cell assembly packaged for integration into a wing of an aircraft in accordance with the present disclosure;

FIG. 3 is a schematic view and partial cross section of one wing of an aircraft, showing details of a fuel cell assembly in direct thermal contact with the leading edge of the aircraft wing in accordance with the present disclosure;

FIG. 4 is a view similar to FIG. 3, showing details of a fuel cell assembly in thermal contact with the leading edge of an aircraft wing through heat pipes in accordance with the present disclosure;

FIG. 5 is a view similar to FIG. 3, showing details of a fuel cell assembly in thermal contact with the leading edge of an aircraft wing through heat pipes in accordance with the present disclosure;

FIG. 6 is a block diagram illustrating control of a fuel cell coolant loop in accordance with the present disclosure; and

FIG. 7 is a view similar to FIG. 1 of an alternative embodiment of a hydrogen fuel-cell-powered aircraft in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for case of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

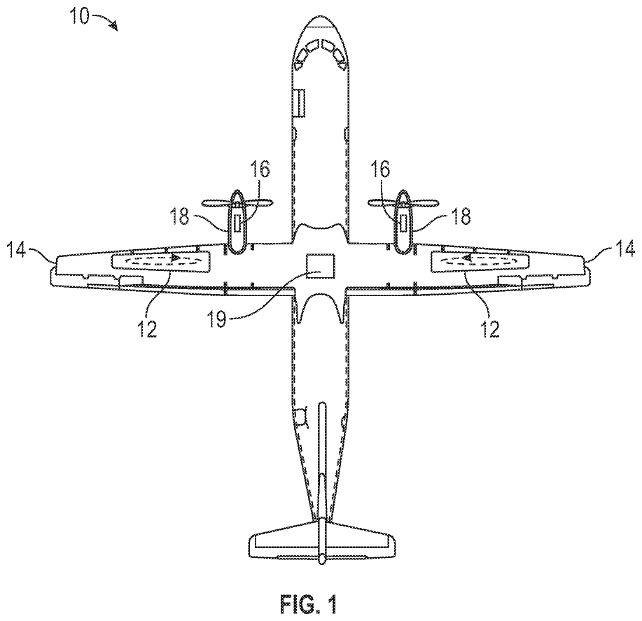

Referring to FIG. 1, there is illustrated an airplane 10 in accordance with the present disclosure. Airplane 10 includes fuel cell assemblies 12 carried within the wings 14 of the aircraft. Electric motors 16 are mounted in engine nacelles 18 on the wings 14. Hydrogen fuel tanks 19 are located in the fuselage of the aircraft.

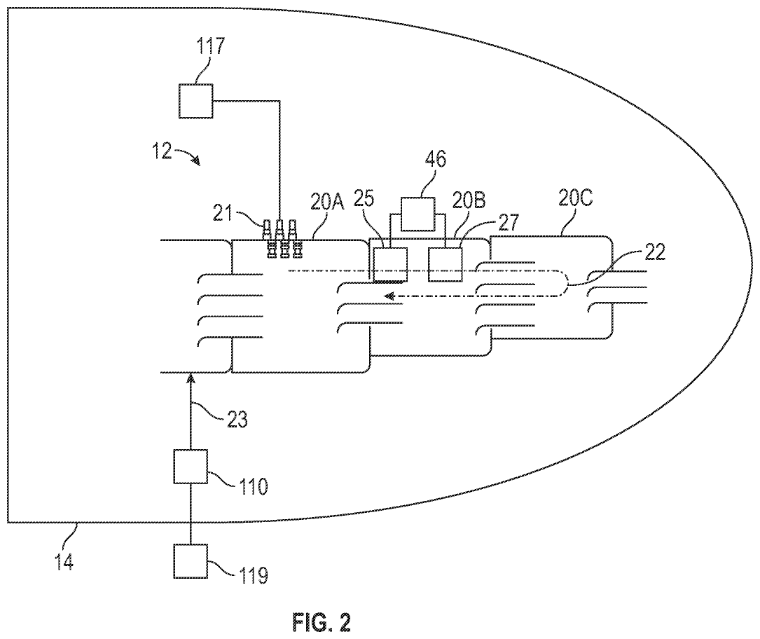

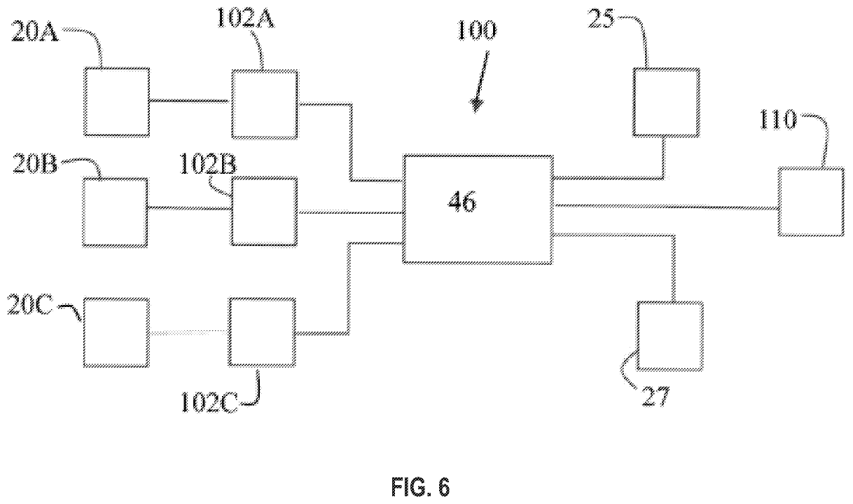

Referring to FIG. 2, a fuel cell assembly 12 comprises a plurality of modular fuel cells 20A, 20B, 20C. Modular fuel cells 20A, 20B, 20C have different exterior dimensions and are shaped to fit into the confines of wing 14. Modular fuel cells 20A, 20B, 20C share a common closed, internal coolant loop 22 which includes a circulating liquid coolant, valves 25 and pumps 27, which are controlled by a controller 46 as depicted in FIG. 6. A hydrogen fuel manifold 21 is connected to a hydrogen fuel source 117, and an air inlet manifold 23 which is connected to an air compressor 119 via air shutters or dampers 110. Fuel cells 20A, 20B, 20C may be connected in series to increase voltage or in parallel to increase current.

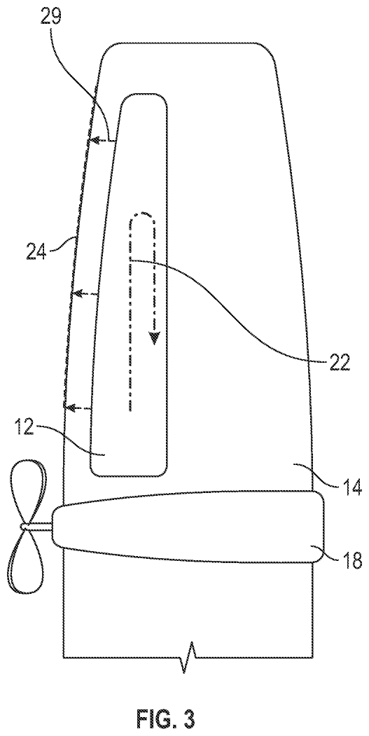

Referring to FIG. 3, in one embodiment, the fuel cell assembly 12 is configured in direct thermal contact by heat sinks 29 with the inside surface of the leading edge 24 of the wing 14.

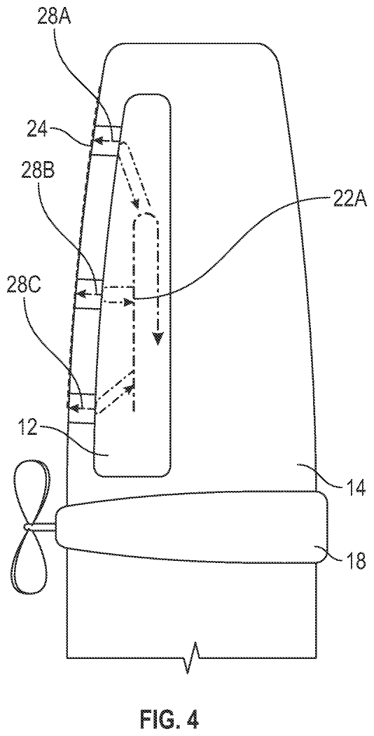

Referring to FIG. 4, in an alternative embodiment, a fuel cell assembly 12 in accordance with the present disclosure is fed via a common hydrogen fuel inlet manifold (not shown) and a ram air inlet (not shown), as before. However, in the FIG. 4 embodiment, the coolant loop comprises an extension coolant loop 22A and includes heat pipes 28A, 28B, 28C, thermally connecting the extension coolant loop 22A to the leading edge 24 of the wing 14. Extension coolant loop 22A also includes valves and pumps (not shown) which are controlled by a controller (not shown) which controls flow of coolant through the extension coolant loop 22A, as described relative to FIG. 6.

Another feature and advantage of transferring rejected heat from the fuel cells to the aircraft wings, in accordance with the present disclosure, is that the heat energy transferred to the wings also may be employed to deice the wings. This eliminates the need for a dedicated deicing system which adds weight and additional consumption of electrical energy for resistive heating.

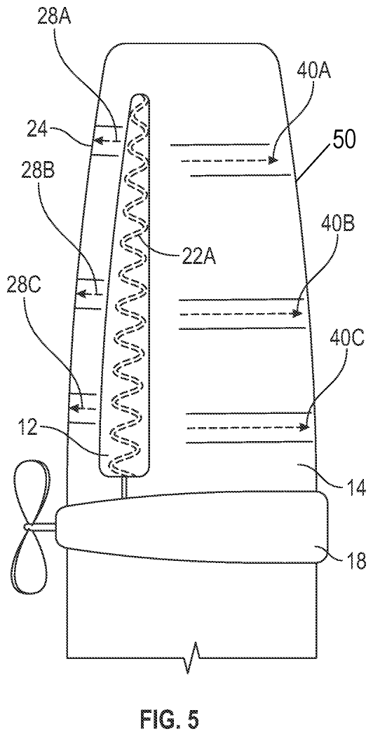

In an alternative embodiment, referencing FIG. 5, the fuel cell assembly 12 optionally may also include heat pipes 40A, 40B, 40C in direct thermal contact with the trailing edge 50 of wing 14. The heat pipes 40A, 40B, 40C are in thermal contact with the extension coolant loop 22A, which is in thermal contact with heat pipes 28A, 28B, 28C, as described relative to FIG. 4. Accordingly, in this embodiment, the thermal energy from the extension coolant loop 22A may be transferred to both the leading edge 24 of the wing 14 and the trailing edge 50 of the wing 14.

Referring to FIG. 6, an exemplary control system 100 in accordance with the present disclosure includes temperature sensors 102A, 102B, 102C configured to sense temperature of the individual fuel cells 20A, 20B, 20C. Sensors 102A, 102B, 102C are operatively connected to controller 46 which is operatively connected to valves 25 and pumps 27 to open valve 25 to activate pump 27 to circulate coolant to maintain the temperature of the fuel cells 20A, 20B, 20C within a target operating range. Controller 46 is also programmed to open and close ram air shutters or dampers 110 to maintain the fuel cells 20A, 20B, 20C within the desired operating range. Also, controller 46 is programmed to control valve 25 and pump 27 to open valve 25 and activate pump 27 to increase flow of thermal energy to the leading edge of the wing 14 when ambient weather conditions are such as to lead to icing conditions on the wings 14.

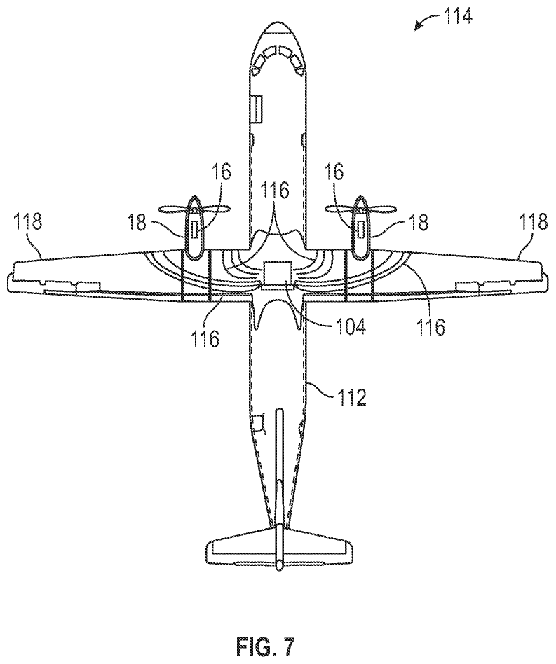

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. By way of example, referring to FIG. 7, fuel cells 104 could be carried within the fuselage 112 of an aircraft 114, and excess heat generated by the fuel cells 104 may be dissipated by circulating heated coolant via heat pipes 116 from the fuel cells 104 to the wings 118 or other external surfaces of the aircraft, such as the engine nacelles 18 of the aircraft. Such variations are not to be regarded as a departure from the disclosure, and all such modifications are intended to be included within the scope of the disclosure. Various changes and advantages may be made in the above disclosure without departing from the spirit and scope thereof.

What is claimed:

1. A fuel-cell-powered aircraft system comprising a fuel cell assembly carried within a wing of an aircraft, wherein the fuel cell assembly is in thermal contact with a surface of the wing.

2. The fuel-cell-powered aircraft system of claim 1, wherein the surface comprises one or more of a leading edge of the wing and a trailing edge of the wing.

3. The fuel-cell-powered aircraft system of claim 1, wherein the fuel cell assembly has an internal coolant loop.

4. The fuel-cell-powered aircraft system of claim 3, wherein the fuel cell assembly is in direct thermal contact with the surface of the wing through heat sinks in contact with the internal coolant loop.

5. The fuel-cell-powered aircraft system of claim 3, wherein the fuel cell assembly is in thermal contact with the surface of the wing through heat pipes in contact with the internal coolant loop.

6. The fuel-cell-powered aircraft system of claim 1, wherein the fuel cell assembly comprises a plurality of fuel cells assembled in a stack shaped for packaging within the wing.

7. The fuel-cell-powered aircraft system of claim 2, further including a controller configured to control flow of coolant to heat pipes in contact with the leading edge of the wing and/or in contact with the trailing edge of the wing.

8. The fuel-cell-powered aircraft system of claim 7, wherein the controller is configured to switch flow of coolant to the heat pipes in contact with the leading edge of the wing and the trailing edge of the wing.

9. The fuel-cell-powered aircraft system of claim 1, wherein the fuel cell assembly comprises a plurality of fuel cells assembled in parallel.

10. The fuel-cell-powered aircraft system of claim 1, wherein the fuel cell assembly comprises a plurality of fuel cells assembled in series.

11. The fuel-cell-powered aircraft of claim 3, further comprising a controller for controlling flow of coolant through the coolant loop.

12. A method for deicing wings of a fuel-cell-powered aircraft, comprising conducting exothermic heat generated by fuel cells to wings of the aircraft.

13. The method of claim 12, wherein the exothermic heat is conducted by direct thermal contact with the fuel cells.

14. The method of claim 12, wherein the exothermic heat is conducted via heat pipes in contact with the fuel cells.

15. The method of claim 12, wherein the exothermic heat is directed to a surface of the aircraft wings.

16. The method of claim 15, wherein the surface comprises one or more of a leading edge of the aircraft wings and/or a trailing edge of the aircraft wings.

17. A method for reducing ram air cooling demands of a fuel-cell-powered aircraft, comprising conducting exothermic heat generated by fuel cells to wings of the aircraft.

18. The method of claim 17, wherein the exothermic heat is directed to a surface of the aircraft wings.

19. The method of claim 18, wherein the surface comprises one or more of a leading edge of the aircraft wings and/or a trailing edge of the aircraft wings.
